(19) United States
(12) Patent Application Publication
(10) Pub. No.: US 2006/0246341 A1
(43) Pub. Date: Nov. 2, 2006

(54) Gas distribution panel for a fuel cell and gas distribution panel containing a fuel cell

(76) Inventors: Ludwig Jörissen, neu-ulm (DE); Joachim Scholta, Nersingen (DE); Frank Häussler, neu-ulm (DE); Weibo Zhang, Neu-Ulm (DE); Werner Lehnert, Langenau (DE)

Correspondence Address: NATH & ASSOCIATES, 112 South West Street, Alexandria, VA, 22314, US

(21) Appl. No.: 10/569,629

(22) PCT Filed: Aug. 26, 2004
(86) PCT No.: PCT/DE04/01890

§ 371 Date: Apr. 19, 2006

(30) Foreign Application Priority Data
Aug. 29, 2003 (DE) 10339974.7
May 28, 2004 (DE) 102004026134.2

(51) Int. Cl. H01M 8/02; H01M 8/10; B32B 3/30

(52) U.S. Cl. 429/38; 429/30; 428/167

(57) ABSTRACT

The invention relates to a gas distribution panel for a fuel cell wherein gas guiding channels having a meandering-shaped structure and which extend in a parallel manner are arranged. The invention is characterized in that cell connectors having various widths are provided on the meander-shaped defining channels in order to reduce transversal transportation of media along the meander-shaped defining channels. The invention also relates to a fuel cell provided with a gas distribution channel arranged on the cathode side and/or anode side, especially a polymer-electrolyte membrane (PEM) fuel cell.

### FIELD OF THE INVENTION

The invention relates to a gas distribution panel for a fuel cell, in which gas supply channels which run parallel are arranged with a meandering structure. The invention furthermore relates to a fuel cell having a gas distribution panel such as this on the cathode side and/or anode side. A fuel cell such as this is, in particular, in the form of a polymer electrolyte membrane (PEM) fuel cell.

### BACKGROUND TO THE INVENTION

Hydrogen or reformat from various sources and processes with an inert gas component of 20 to about 70% are converted to electricity on the anode side of PEM fuel cells. Air is virtually always used as the oxygen source on the cathode side.

In both cases, the important factor is to convert the reaction gases to as great an extent as possible, while maintaining the cell voltage. This requires that the reaction gases be supplied uniformly over the cell in a manner which as far as possible avoids depletion zones which locally lead to a greatly reduced current density.

A further aim is to be able to still supply the gas in at least one direction at a sufficiently high speed to remove droplets.

### PRIOR ART

In order to achieve a sufficiently high speed, it is known for the gas to be supplied by individual channels or via a plurality of channels which are arranged parallel, and have a meandering structure. These channels may extend uniformly over the active area, or may also include local branches with a more complex structure.

It is likewise known that a uniform speed distribution can be achieved in the channels with a suitable channel arrangement, such as similar channel lengths and a similar number of curves in the individual channels.

In the case of the channel arrangement which is described by way of example in DE 100 15 360 A1, which has a meandering structure, according to the prior art, a number of channels run alongside one another, whose static pressures differ considerably from one another, since relatively long paths with different pressure drops may be located between the mutually adjacent gas channels. This results in lateral diffusion via the gas diffusion layer, which leads to local enrichment of the reactants and to a partial hydraulic short-circuit of specific channel parts, which in its own right leads to depletion of the reactants in other areas of the active surface, and to a reduction, resulting from this, in the achievable current density.

In consequence, the corresponding fuel cell stack must be operated at a lower conversion level, which in turn leads to poorer system efficiency.

### OBJECT OF THE INVENTION

The invention is based on the object of providing a gas distribution panel for a fuel cell, in which the gas supply channels have a meandering structure, with the lateral diffusion via the gas diffusion layer which occurs at the channels being reduced to such an extent that an approximately uniform gas distribution is achieved over the entire meander length. A further aim is to provide a fuel cell whose reaction gas conversion levels are as high as possible and which allows a high system efficiency.

### SUMMARY OF THE INVENTION

According to the invention, the above object is achieved by a gas distribution panel as claimed in claim 1, and by a fuel cell as claimed in claim 5.

Preferred and particularly expedient embodiments of the subject matter of the application are specified in the dependent claims.

In the case of the gas distribution panel according to the invention, the lateral transport of media along the media boundary channels is reduced, thus results in a uniform flow through all of the channels. This allows the fuel cells to be constructed with a high conversion level and efficiency.

### DETAILED DESCRIPTION OF THE INVENTION

The subject matter of the invention is thus a gas distribution panel for a fuel cell, in which gas supply channels which run parallel are arranged with a meandering structure, characterized in that ribs or webs with a varying width are provided on the meander boundary channels in order to reduce the lateral transport of media along the meander boundary channels.

The subject matter of the invention is also a fuel cell having a gas distribution panel such as this on the cathode side and/or anode side.

According to the invention, it has thus been found that the object mentioned above can be achieved in that the width of the web which is provided at the relevant junctions in the gas supply channels is varied in such a way that the lateral flow that occurs is just enough to allow an adequate reactant concentration in the reaction zone above the relevant web section.

According to the invention, two configurations are provided for the variation of the web width on the meander boundary channels:
a) broadening of the relevant web by a constant amount,
b) broadening of the relevant web by a variable amount, specifically broadening of the relevant web in a wedge shape.

Configuration a) allows a solution according to the invention of the lateral flow problems. However, the broadening in a web area with only a short bridging channel length allows a certain amount of depletion of the reactant concentration to occur. Variant b) is thus particularly preferable, which allows the solution according to the invention to the lateral flow problem without having to accept reactant depletion over the web part with a short channel length.

The specific extent of the additional broadening and the additional wedge shape is dependent on the characteristics of the chosen gas diffusion layer and the chosen channel geometries. Geometries which are effective according to the invention can be determined not only by model calculations but also by determination of the performance characteristics of fuel cells constructed with the web geometries being varied.

The construction on the components of a fuel cell according to the invention correspond to the prior art, with the exception of the gas distribution panel according to the invention on the cathode side and/or anode side, preferably both on the cathode side and on the anode side. It is particularly preferable for the fuel cell according to the invention to be in the form of a polymer electrolyte membrane (PEM) fuel cell.

### PREFERRED EMBODIMENTS OF THE INVENTION

The invention will be explained in more detail using preferred embodiments and with reference to the drawings, in which:

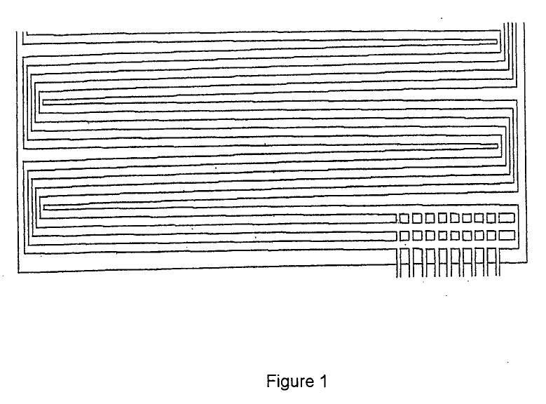

FIG. 1: shows the detail of a gas distribution panel, designed according to the invention, for a fuel cell;

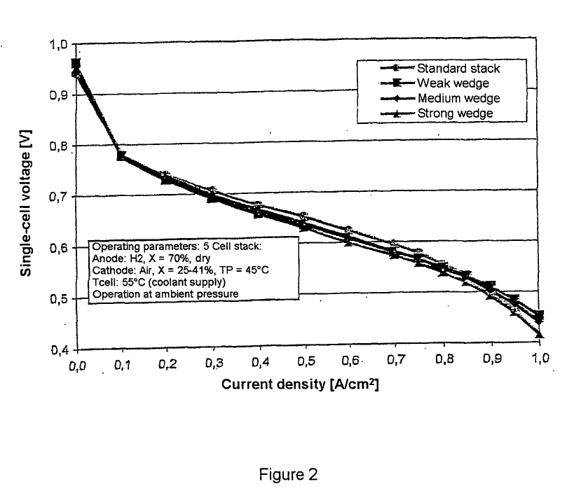

FIG. 2: shows current/voltage characteristics for gas distribution panels constructed according to the prior art and for gas distribution panels according to the invention; and

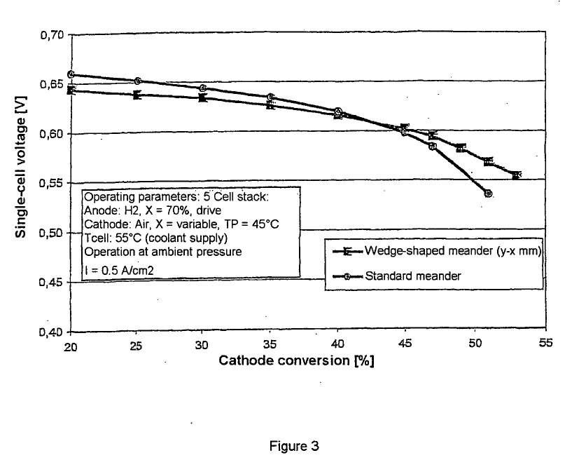

FIG. 3: shows conversion characteristics for a fuel cell constructed according to the prior art, and for a fuel cell according to the invention.

The exemplary embodiment shown in FIG. 1 illustrates the arrangement according to the invention on the basis of a triple meander. However, the invention is not restricted to this arrangement but applies to any desired number of channels which run parallel. The preferred wedge shape results in a structure which is slightly inclined with respect to the horizontal and vertical and has additional advantages, in the form of easier removal of water droplets, if the main flow direction is downwards.

The invention will be explained with reference to a polymer membrane fuel cell, without being restricted to this cell type.

An exemplary embodiment of a gas distribution panel (flowfield) constructed according to the invention will be explained with reference to a polymer membrane fuel cell with an active area of 100 cm².

A cell constructed according to the prior art has a flowfield with a triple parallel meander with a channel and web width of about 0.8 mm. The channel depth is in the range from 1.2 to 1.6 mm. According to the prior art, the inlet and outlet flow areas are constructed such that a uniform flow into all of the channels of a parallel meander is made possible by means of webs which are interrupted a plurality of times in this area. The arrangements of the meanders on the anode side and cathode side allow flow to pass in the same flow direction, in a crossed-over flow direction, or in the opposite flow direction. In the exemplary embodiment, the meanders are arranged such that the media can flow both in the same direction and in the opposite direction.

The cell with the flowfield constructed according to the invention is constructed in the manner described above, but has a wedge-shaped profile at the webs with opposite flow directions, and hence corresponding increased pressure differences. At the flow-reversal end of the web, this web has the same width as the other webs. Towards the other end, the web becomes thicker uniformly to a width of 1.8 mm, so that the lateral flow that occurs at this end across the web (caused by the increased pressure difference) is reduced approximately to such an extent that this results in a media supply that is still just adequate across the web.

In comparison to the prior art, this arrangement leads to the expectation of an improved cell voltage, particularly at relatively high current densities and with increased gas and air conversion levels.

FIG. 2 shows corresponding current/voltage characteristics for a) flowfields constructed according to the prior art, and b) flowfields constructed according to the invention. As can be seen, the invention makes it possible to achieve a significant improvement in the characteristic profile at high current densities.

Furthermore, a cell constructed according to the invention has an improved profile of the conversion characteristic, as can be seen in FIG. 3.

It is self-evident that a cell constructed according to the invention has a cell voltage which is improved by up to 50 mV at conversion levels of more than 45%, which can be explained by the lateral diffusion being reduced by the wedge-shaped webs according to the invention, and by the more uniform flow distribution that this results in.

1. A gas distribution panel for a fuel cell, in which gas supply channels which run parallel are arranged with a meandering structure, characterized in that webs with a varying width are provided on the meander boundary channels in order to reduce the lateral transport of media along the meander boundary channels.

2. The gas distribution panel as claimed in claim 1, characterized in that webs with an increasing width are provided on the meander boundary channels.

3. The gas distribution panel as claimed in claim 2, characterized in that webs with a width which increases in a wedge-shaped manner are provided on the meander boundary channels.

4. The gas distribution panel as claimed in claim 1, characterized in that webs with a uniformly increased width in comparison to the other webs are provided on the meander boundary channels.

5. A fuel cell having a gas distribution panel as claimed in claim 1, on the cathode side and/or anode side.

6. The fuel cell as claimed in claim 5, in the form of a polymer electrolyte membrane (PEM) fuel cell.

7. A fuel cell having a gas distribution panel as claimed in claim 2, on the cathode side and/or anode side.

8. A fuel cell having a gas distribution panel as claimed in claim 2, on the cathode side and/or anode side.

9. A fuel cell having a gas distribution panel as claimed in claim 3, on the cathode side and/or anode side.

10. A fuel cell having a gas distribution panel as claimed in claim 4, on the cathode side and/or anode side.
